(19) United States
(12) Patent Application Publication
(10) Pub. No.: US 2023/0411722 A1
(43) Pub. Date: Dec. 21, 2023

(54) LITHIUM-RICH COMPOSITIONS

(71) Applicant: Redwood Materials, Inc., Carson City, NV (US)

(72) Inventors: Jay T. SAUNDERS, II, Reno, NV (US); Jeffrey B. STRAUBEL, Washoe Valley, NV (US)

(21) Appl. No.: 18/211,053

(22) Filed: Jun. 16, 2023

Related U.S. Application Data
(63) Continuation of application No. PCT/US2021/064429, filed on Dec. 20, 2021.
(60) Provisional application No. 63/128,762, filed on Dec. 21, 2020.

(51) Int. Cl. H01M 10/54; C22B 7/00; C22B 3/22

(52) U.S. Cl. CPC H01M 10/54; C22B 7/004; C22B 7/007; C22B 3/22

(57) ABSTRACT

The present disclosure relates to the production of lithium-enriched compositions from lithium-ion batteries, and the processing of those compositions for the economic recovery of lithium compounds useful for commercial and industrial applications.

### CROSS-REFERENCE TO RELATED APPLICATIONS

This application claims the benefit of U.S. Provisional Application No. 63/128,762 filed Dec. 21, 2021, the disclosure of which is hereby incorporated by reference in its entirety.

### TECHNICAL FIELD

This invention relates to the recycling of lithium-ion batteries to produce specific lithium-rich compositions that enable the selective and effective recovery of lithium.

### BACKGROUND

Lithium-ion batteries (LIBs) have become an integral source of stored power due to their high energy densities, coulombic efficiencies, and diverse electrode designs. For the past several decades, LIBs have been used extensively in portable electronic devices and, more recently, in electric and hybrid vehicles, buses, and large-scale energy storage systems. It is predicted that the LIB market size will more than double between 2020 and 2025, with the largest application being electric vehicles (Fan, E. et al. Chemical Reviews, 2020, 120(14), 7020-2063).

The majority of global lithium production, which supplies industrial and commercial applications including the manufacture of LIBs, occurs inefficiently via extraction from brine and lithium-bearing minerals such as spodumene, lepidolite, and petalite, amblygonite, eucryptite, and zinnwaldite. Even the most lithium-rich of these sources have a theoretical lithium content of less than 5%, and the extraction processes cause significant social and environmental harm. Given the projected increase in demand for lithium, recycling of lithium-containing batteries is becoming an increasingly important part of the global lithium supply chain. As it currently stands, however, recycling of LIBs to recover lithium poses significant challenges.

The two primary approaches to LIB recycling involve hydrometallurgical and pyrometallurgical processes. In hydrometallurgical processes, aqueous solutions are used to leach metals from battery cathodes. Traditional hydrometallurgical processes require time-consuming steps, high operational costs, and dangerous pretreatment and dismantling of whole batteries. Further, individual metal components are difficult to separate from the leach solution due to their similar chemical properties. In pyrometallurgical processes, batteries are subjected to high temperature reduction smelting, where valuable metals are recovered as a metal phase alloy. A slag containing predominantly lithium and aluminum oxides is also formed, however the lithium is present in a low concentration, and it is therefore difficult to extract lithium cleanly from the aluminum and other contaminants. For this reason, the slag is usually discarded in landfills, representing a significant waste of a metal that is becoming increasingly important in industry and in consumer electronics.

Accordingly, there is a need both for new ways to recycle LIBs to produce a high-lithium-concentration material, and for new ways to process these materials to cleanly provide lithium compounds that can be returned to the supply chain, especially as battery grade materials.

### SUMMARY

Lithium concentrates and their methods of production and processing are disclosed herein. In some variations, the lithium concentrate may contain about 13% to 30% Li₂O. The lithium concentrate may contain about 25% to about 55% SiO₂. The lithium concentrate may also contain about 25% to about 55% Al₂O₃.

Processes for producing a lithium concentrate are also disclosed herein. In one variation, the process includes feeding lithium batteries, battery scrap, or battery components into a furnace. The process may include blowing or injecting an oxygen-containing gas into the furnace to produce a metal phase and a lithium concentrate phase, wherein heating is autothermal. The process may also include separating the metal phase from the lithium concentrate phase.

Also disclosed herein are processes for extracting lithium from a lithium concentrate. The process may include reducing the size of the lithium concentrate. The process may include acidifying a slurry of the size-reduced lithium concentrate in water by addition of at least one acid. The process may also include neutralizing the acidic slurry to a pH of about 7. The process may include filtering the solids from the neutralized slurry, thereby obtaining a clarified lithium-enriched solution of a lithium salt.

### BRIEF DESCRIPTION OF THE DRAWINGS

FIG. 1 shows a ternary phase diagram for lithium concentrates.

FIG. 2 shows a computed plot of percent lithium as lithium metasilicate in a concentrate, as a function of SiO₂.

FIG. 3 shows a schematic of a process for producing a lithium concentrate from LIBs.

FIG. 4 shows a schematic of a process for selectively leaching lithium from a lithium concentrate.

### DETAILED DESCRIPTION

Non-limiting examples of various aspects and variations of the invention are described herein and illustrated in the accompanying drawings.

Described herein are high-concentration lithium compositions (“lithium concentrates”) produced from the recycling of LIBs. Such compositions can be produced from whole LIBs or their parts, independent of the specific battery makeup. Also described herein are the processes for producing the high-concentration lithium compositions, and processes for selectively isolating lithium in an industrially useful form therefrom.

There are currently limited methods of processing discarded LIBs to produce high-lithium-content materials that are useful in the recovery of lithium. In processes where lithium can be removed from batteries, it is present in low concentrations and in combination with other materials, such as aluminum, making the recovery of lithium metal uneconomical. These materials are often discarded. In contrast, the compositions described herein, and the methods of forming and processing them, provide a way of recovering lithium from LIBs for return to industrial supply chains. The beneficial details of these compositions, described herein as “lithium concentrates”, and associated processes are described in detail below.

Lithium Concentrates

Briefly, in known pyrometallurgical processes for the recycling of LIBs, batteries or battery components are put into a smelting furnace with fluxing compounds. The high temperature facilitates oxidation and reduction reactions, whereby easily oxidized elements such as lithium and aluminum are converted to their oxides, collecting in a slag phase. Transition metals such as cobalt, nickel, and manganese are reduced from their oxides, collecting in a metal alloy phase. The metal alloy phase is recovered, and its constituent elements are separated and sold. As described above, however, the slag is typically discarded because its low lithium content relative to aluminum and SiO₂ makes clean recovery of lithium difficult and uneconomical.

In contrast to known pyrometallurgical slags, the lithium concentrates disclosed herein contain high levels of Li₂O (e.g., in excess of 20%). A known Umicore Battery Recycling Process, for instance, has been shown to produce a slag with a Li₂O content of about 11% (Elwert, T. et al, Phase Composition of High Lithium Slags from the Recycling of Lithium Ion Batteries, World of Metallurgy—ERZMETALL 65(2012) No. 3, pg. 5-12). Additionally, in traditional pyrometallurgical processing of LIBs, limestone (CaCO₃) is added to the smelt as a fluidizer. Other fluidizers include CaO and Ca(OH)₂. The lithium concentrates disclosed herein contain low levels of calcium, which the presence of which would problematic in further processing. In compositions of the present disclosure, the combination of high Li₂O relative to silicon content, and low CaO, of these lithium concentrates allows for the facile and selective recovery of lithium during an extraction process (vide infra).

For sake of clarity, percent of a constituent of a composition described herein, including lithium concentrates, can mean w/v, w/w, or v/v percent. For example, “about 13%” can be read to mean about 13% weight/volume (% w/v), about 13% weight/weight (% w/w), or about 13% volume/volume (% v/v).

A lithium concentrate disclosed herein may comprise Li₂O, SiO₂ and Al₂O₃. These lithium concentrates are contrasted with known pyrometallurgical slags, which have low a lithium content. For instance, the lithium concentrate may comprise about 13% to about 30% Li₂O. In some embodiments, the lithium concentrate comprises about 15% to about 30% Li₂O. In certain embodiments, the lithium concentrate comprises about 20% to about 30% Li₂O. In certain embodiments, the lithium concentrate comprises about 25% to about 30% Li₂O. In certain embodiments, the lithium concentrate comprises about 13% to about 25% Li₂O. In certain embodiments, the lithium concentrate comprises about 15% to about 25% Li₂O. In certain embodiments, the lithium concentrate comprises about 20% to about 25% Li₂O. In certain embodiments, the lithium concentrate comprises about 13% to about 20% Li₂O. In some embodiments, the lithium concentrate comprises about 15% to about 20% Li₂O. These high-lithium content concentrates enable efficient and clean extraction of lithium.

Because silicon might be present in a LIB being recycled, and because silicon can be added during the production of the lithium concentrates disclosed herein, the lithium concentrates may comprise about 25% to about 55% SiO₂. In some embodiments, the lithium concentrate comprises about 25% to about 55% SiO₂. In certain embodiments, the lithium concentrate comprises about 25% to about 50% SiO₂. In certain embodiments, the lithium concentrate comprises about 25% to about 45% SiO₂. In certain embodiments, the lithium concentrate comprises about 25% to about 40% SiO₂. In certain embodiments, the lithium concentrate comprises about 25% to about 35% SiO₂. In certain embodiments, the lithium concentrate comprises about 25% to about 30% SiO₂. In certain embodiments, the lithium concentrate comprises about 30% to about 50% SiO₂. In certain embodiments, the lithium concentrate comprises about 30% to about 45% SiO₂. In certain embodiments, the lithium concentrate comprises about 30% to about 40% SiO₂. In certain embodiments, the lithium concentrate comprises about 30% to about 35% SiO₂. In certain embodiments, the lithium concentrate comprises about 35% to about 50% SiO₂. In certain embodiments, the lithium concentrate comprises about 35% to about 45% SiO₂. In certain embodiments, the lithium concentrate comprises about 35% to about 40% SiO₂. In certain embodiments, the lithium concentrate comprises about 40% to about 50% SiO₂. In some embodiments, the lithium concentrate comprises about 40% to about 45% SiO₂.

Aluminum is also present in the lithium concentrates, which may comprise about 25% to about 55% Al₂O₃. In some embodiments, the lithium concentrate comprises about 25% to about 55% Al₂O₃. In certain embodiments, the lithium concentrate comprises about 25% to about 50% Al₂O₃. In certain embodiments, the lithium concentrate comprises about 25% to about 45% Al₂O₃. In certain embodiments, the lithium concentrate comprises about 25% to about 40% Al₂O₃. In certain embodiments, the lithium concentrate comprises about 25% to about 35% Al₂O₃. In certain embodiments, the lithium concentrate comprises about 25% to about 30% Al₂O₃. In certain embodiments, the lithium concentrate comprises about 30% to about 50% Al₂O₃. In certain embodiments, the lithium concentrate comprises about 30% to about 45% Al₂O₃. In certain embodiments, the lithium concentrate comprises about 30% to about 40% Al₂O₃. In certain embodiments, the lithium concentrate comprises about 30% to about 35% Al₂O₃. In certain embodiments, the lithium concentrate comprises about 35% to about 50% Al₂O₃. In certain embodiments, the lithium concentrate comprises about 35% to about 45% Al₂O₃. In certain embodiments, the lithium concentrate comprises about 35% to about 40% Al₂O₃. In certain embodiments, the lithium concentrate comprises about 40% to about 50% Al₂O₃. In some embodiments, the lithium concentrate comprises about 40% to about 45% Al₂O₃.

In general, the lithium concentrates disclosed herein may comprise about 13% to about 30% Li₂O; about 25% to about 55% SiO₂; and about 25% to about 55% Al₂O₃. In some embodiments, the lithium concentrate comprises 20% to about 25% Li₂O; about 30% to about 45% SiO₂; and about 35% to about 45% Al₂O₃. In some embodiments, the lithium concentrate comprises 20% to about 25% Li₂O; about 30% to about 45% SiO₂; and about 35% to about 45% Al₂O₃. In certain embodiments, the lithium concentrate comprises 20% to about 25% Li₂O; about 30% to about 35% SiO₂; and about 40% to about 45% Al₂O₃. In certain embodiments, the lithium concentrate comprises 20% to about 25% Li₂O; about 35% to about 40% SiO₂; and about 40% to about 45% Al₂O₃. In certain embodiments, the lithium concentrate comprises 13% to about 20% Li₂O; about 30% to about 55% SiO₂; and about 30% to about 45% Al₂O₃.

In some embodiments, the lithium concentrates disclosed herein may comprise about 13% to about 30% Li₂O; about 25% to about 55% SiO₂; about 25% to about 55% Al₂O₃; about to about 5% CaO; and about 0% to about 5% MnO.

Uniquely, the lithium concentrates described herein may be produced without fluidizers, and the concentrates therefore may be free of CaO. However, residual calcium might still be present as contaminants in other additives. As a result, in some embodiments, the lithium concentrate may comprise about 0.01% to about 5% CaO. In certain embodiments, the lithium concentrate comprises less than about 1%, about 1%, about 2%, about 3%, about 4%, or about 5% CaO. In some embodiments, the lithium concentrate does not comprise CaO.

Additionally, unlike in slags produced by traditional pyrometallurgical processing of LIBs, the lithium concentrates disclosed herein were developed to be low in manganese, allowing for easier eventual extraction of the pure lithium. It has been found that the lithium concentrates may comprise about 0% to about 5% MnO. In certain embodiments, the lithium concentrate comprises less than about 1%, about 1%, about 2%, about 3%, about 4%, or about 5% MnO. In some embodiments, the lithium concentrate does not comprise MnO.

In some variations, the lithium concentrates disclosed herein may comprise about to about 5% CaO and about 0% to about 5% MnO.

The chemical makeup of lithium concentrates described herein may be determined, for example, by X-ray fluorescence (XRF) spectroscopy or Inductively Coupled Plasma Optical Emission Spectrometry (ICP-OES). One skilled in the art will appreciate that compositions of the type disclosed herein can be analyzed by these methods and then expressed, for convenience, in terms of metal oxide and metal content (e.g., Li₂O, Al₂O₃, SiO₂, CaO, MnO, Fe, Ni, Co).

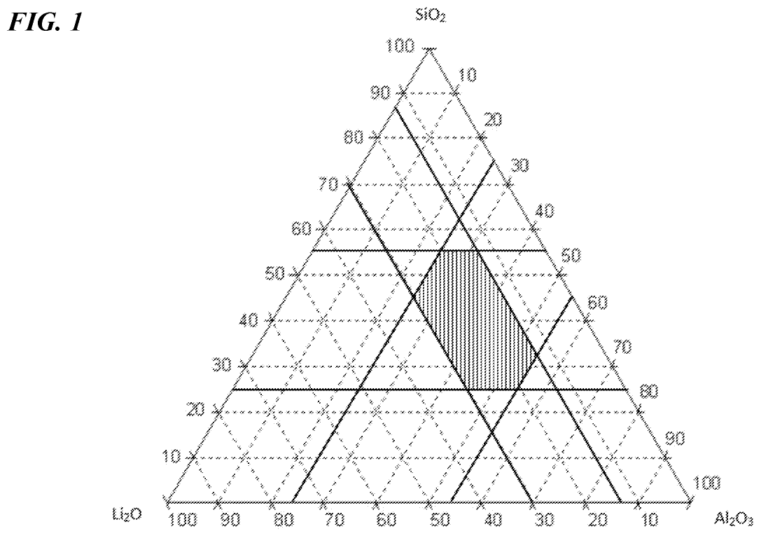

Solid lithium concentrates can also be described in terms of their discrete crystalline phases, as predicted by theoretical thermodynamic calculations, or as determined empirically by X-ray diffraction (XRD) analysis. In this case, the composition can be additionally expressed in terms of crystalline silicate or aluminate structure (e.g., Li₂SiO₃, LiAlO₂, LiAl₅O₄, LiAlSiO₄), corresponding to an equivalent general oxide content as described above. The solid lithium concentrates described herein, compared to known slags, have a majority of the Li₂O content entrapped in crystalline lithium metasilicate (Li₂SiO₃), rather than in aluminates like LiAlO₂ and LiAl₅O₈. The particular crystalline phase composition of these concentrates enables the advantages in production and processing described herein. The shaded region of the example ternary diagram shown in FIG. 1 defines the approximate boundaries for the phase of the lithium concentrates described herein. It should be noted that this diagram describes the approximate boundaries for phases of the concentrate in terms of Li₂O, SiO₂, and Al₂O₃, and does not include other elements that might be present (e.g., calcium, manganese, iron, nickel, cobalt).

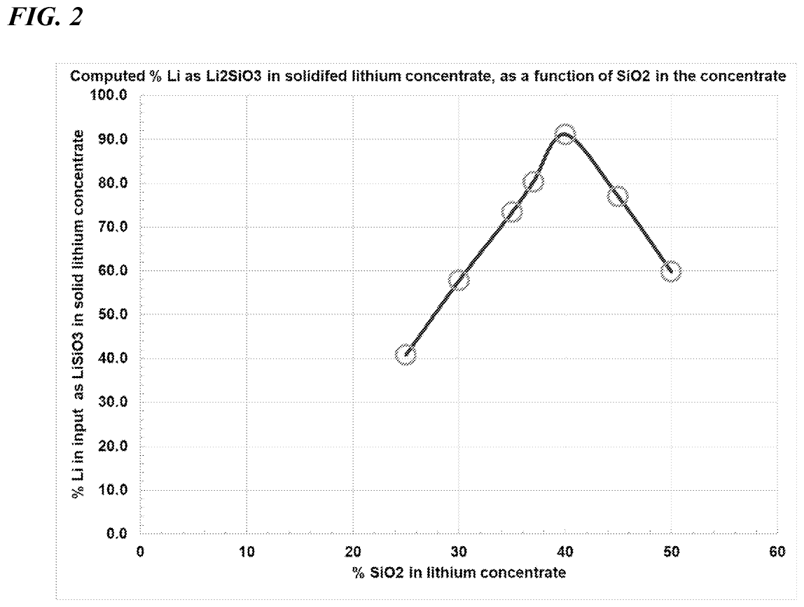

FIG. 2 shows a computed plot of percent lithium as lithium metasilicate in a concentrate, as a function of SiO₂, determined by thermodynamic calculations using FactSage™ Using this model, the crystalline phase composition can be modeled for the presently disclosed concentrates or for slags known in the art (Table 1). For instance, the above-mentioned process discussed in Elwert, et al., as modeled, produces compositions with under 10% lithium metasilicate. In contrast, the present lithium concentrates contain greater than 25% lithium metasilicate, allowing for viable extraction of lithium free of impurities. For example, Composition 2, described in Example 1, contains 55% Li₂SiO₃, corresponding to 84% of lithium of the concentrate being found in this crystalline phase. In some embodiments of the concentrates described herein, between about 40% and about 95% lithium is found in the Li₂SiO₃ phase.

TABLE 1
Relationship between lithium-containing composition
and modeled lithium-containing crystalline phases

| | | Li₂SiO₃, % | LiAlO₂, % | LiAl₅O₈, % |
|---|---|---|---|---|
| Entry 1 | “Current” from | 7.8 | 39.9 | 0 |
| | Elwert, et al. | | | |
| Entry 2 | “Hi Al” from | 0 | 49 | 0 |
| | Elwert, et al. | | | |
| Entry 3 | Composition 2 - | 55 | 9 | 29 |
| | Example 1 | | | |

In some embodiments, the concentrates described herein may contain between about 25% and about 60% Li₂SiO₃; between about 0% and about 65% LiAlO₂; between about 0% and about 35% LiAl₅O₈; between about 0% and about 60% LiAlSiO₄; and between about 0% and about 2% Li₄SiO₄. In certain embodiments, the concentrates described herein may contain between about 35% and about 57% Li₂SiO₃; between about 0% and about 45% LiAlO₂; between about 0% and about 35% LiAl₅O₈; between about 0% and about 5% LiAlSiO₄; and between about 0% and about 1% Li₄SiO₄.

Process for Producing a Lithium Concentrate

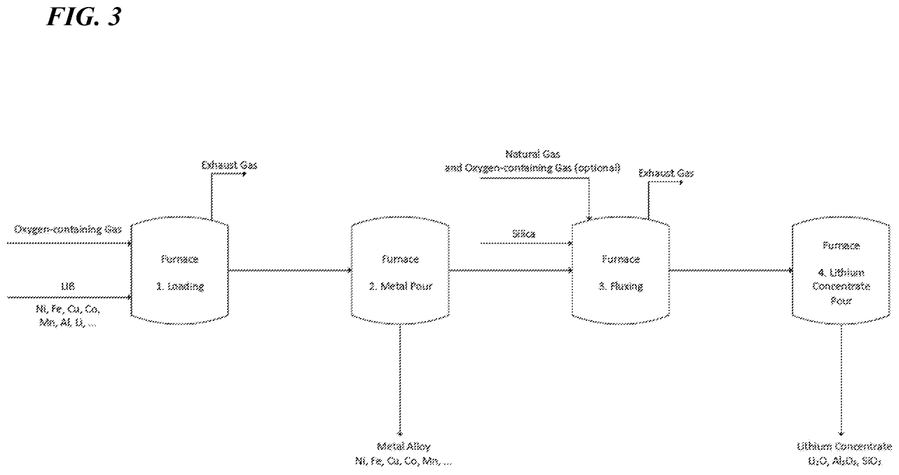

As described above, lithium batteries can be smelted in a pyrometallurgical process to produce slag and metal alloy, however the slag generally has a composition unsuitable for efficient lithium reclamation due to low lithium concentration and the presence of other difficult-to-separate materials. The lithium concentrates presented herein can be prepared using a pyrometallurgical process developed to overcome the deficiencies of traditional methods. FIG. 3 shows an example schematic of a process for producing a lithium concentrate described herein.

The processes disclosed herein for producing a lithium concentrate may comprise feeding lithium batteries, battery scrap, or battery components into a smelter, furnace, or any similar metallurgical vessel. The batteries, battery scrap, or battery components may be fed into the furnace by any reasonable means, including by hopper or conveyer, and may be fed at a rate reasonable for the size of the furnace and for the control of reaction kinetics and heat transfer. The batteries may, for instance, be fed into the furnace at a rate of 50 kg/hr, 100 kg/hr, 150 kg/hr, 200 kg/hr, 250 kg/hr, 300 kg/hr, 350 kg/hr, or 400 kg/hr.

The furnace may be optionally configured to rotate to allow for mixing of the contents. The furnace may be rotated at any rate reasonable for efficient mixing of the contents. In some embodiments, the furnace is rotated between about 1 and about 20 RPM. The furnace may be equipped with a lance, burner, or the like, that is capable of blowing or injecting oxygen-containing gases into the furnace, either above or submerged within the melt. As described above, in contrast with traditional pyrometallurgical processing of LIBs, CaO or CaCO₃ do not need to be added to the batteries in the processes disclosed herein.

The processes disclosed herein can further comprise blowing or injecting an oxygen-containing gas into the furnace to produce a metal phase and a lithium concentrate phase. The oxygen-containing gas can be pure oxygen or can be mixed with other gases. In some embodiments, the oxygen is blown or injected with natural gas via a burner capable of combusting the two. However, the processes for producing a lithium concentrate as described herein do not require an external heating source, including fossil fuels like natural gas. Instead, heating may be autothermal, wherein organics (e.g., plastics, electrolytes, graphite) in the batteries combust in the presence of the oxygen-containing gas, providing sufficient heating to effect the oxidation/reduction reactions that form the lithium concentrate and metal alloy phases. In some embodiments, heating is autothermal. In certain embodiments, no external heating is used. Current pyrometallurgical processes require additional heat input at this stage.

The flow rate of the oxygen-containing gas may be controlled to selectively deport individual elements to the metal phase or to the lithium concentrate phase. For example, the oxygen-containing gas may be fed into the furnace such that the rate of oxygen fed is between about 10 Nm³/hr and about 100 Nm³/hr per 100 kg of battery. In other words, for 30 Nm³/hr of oxygen, 37.5 Nm³/hr of an oxygen-containing gas containing 80% oxygen would be required. In some embodiments, the oxygen-containing gas is fed into the furnace such that the rate of oxygen fed is between about 20 Nm³/hr and about 40 Nm³/hr per 100 kg of battery. In some embodiments, the oxygen-containing gas is fed into the furnace such that the rate of oxygen fed is about 20 Nm³/hr, about 30 Nm³/hr, or about 40 Nm³/hr per 100 kg of battery. In some embodiments, lithium and aluminum present in the lithium batteries, battery scrap, or battery components are oxidized. In some embodiments, the oxidized lithium and aluminum deport to the lithium concentrate phase. Conversely, non-aluminum and non-lithium metals present in the lithium batteries, battery scrap, or battery components are reduced. Examples of such metals include Co, Cr, Cu, Fe, Mn, Ni, and Ti. In some embodiments, the non-aluminum and non-lithium metals deport to the metal phase.

The flow rate of the oxygen-containing gas may be controlled to maintain the furnace temperature within a set range. In some embodiments of the processes disclosed herein, the oxygen-containing gas rate may be controlled to maintain the furnace temperature between about 1300° C. and about 1800° C. In certain embodiments, the oxygen-containing gas rate may be controlled to maintain the furnace temperature between about 1350° C. and about 1800° C.; about 1300° C. and about 1700° C.; about 1300° C. and about 1600° C.; about 1300° C. and about 1500° C.; about 1300° C. and about 1400° C.; about 1400° C. and about 1800° C.; about 1400° C. and about 1700° C.; about 1400° C. and about 1600° C.; about 1400° C. and about 1500° C.; about 1500° C. and about 1800° C.; about 1500° C. and about 1700° C.; about 1500° C. and about 1600° C.; about 1600° C. and about 1800° C.; or about 1600° C. and about 1700° C.

Notably, the processes disclosed herein do not require the addition of a flux during loading of the batteries, battery scrap, or battery components, or during treatment with oxygen. This contrasts with current pyrometallurgical processes which require the addition of flux. Flux is typically necessary to help separate metals from the oxides of the slag phase, or to help liquefy or adjust the viscosity of the slag. In some embodiments of the processes described herein, flux is not added during the battery loading or oxygen addition stages. In some embodiments, flux is added during these stages. In some embodiments, the flux is added after forming the metal phase. Examples of flux include sand and limestone.

The processes described herein may comprise separating the metal phase from the lithium concentrate phase. For instance, in some embodiments, a solid lithium concentrate phase is produced. In certain embodiments, a liquid lithium concentrate is produced. In some embodiments, the metal phase is a liquid and is decanted from the solid lithium concentrate phase. The processes of the present disclosure may produce a solid lithium concentrate of lithium and aluminum, largely free from impurities. In traditional pyrometallurgical processing of LIBs, the slag and metal phases are both liquid. Because the processes disclosed herein enable production of a solid lithium concentrate phase, they offer several advantages over traditional methods, including reduced heating requirements during the oxidation/reduction phase, improved reaction kinetics, and reduced metal loss. Additionally, the solid lithium concentrate cannot foam, an operational problem that occurs with liquid slag causing reduced furnace capacity and throughput. The solid lithium concentrate also coats and protects the furnace refractory, allowing for the use of cheaper refractories and extending their lifetimes by reducing their exposure to corrosive components of the LIBs. Further, lithium lost to the fumes via vaporization is minimized due to the lower operating temperatures.

Once the metal phase is separated from the solid lithium concentrate, the lithium concentrate may be isolated. In some embodiments, flux is added to the solid lithium concentrate in order to liquefy it for removal from the furnace. The flux may comprise, for instance, SiO₂ or spodumene concentrate. In some embodiments SiO₂ is added. In some embodiments, SiO₂ is added to the lithium concentrate phase. Because heat is lost during the metal decantation, in some embodiments, additional heat may be added with the flux to make the lithium concentrate molten. In some embodiments, about 20 Nm³/hr, 30 Nm³/hr, or about 40 Nm³/hr natural gas per 100 kg battery, and about 50 Nm³/hr, about 60 Nm³/hr, or about 70 Nm³/hr oxygen per 100 kg battery may be combusted to make the lithium concentrate molten. In some embodiments, the liquid lithium concentrate is removed from the furnace.

These processes for recycling LIBs are useful for producing the lithium concentrates described herein. For instance, the process may produce a lithium concentrate comprising about 13% to about 30% Li₂O; about 25% to about 55% SiO₂; and about 25% to about 55% Al₂O₃. In some embodiments, the process may produce a lithium concentrate comprising about 13% to about 30% Li₂O; about 25% to about 55% SiO₂; about 25% to about 55% Al₂O₃; about 0.01% to about 5% CaO; and about 0% to about 5% MnO.

Process for Selectively Leaching Lithium from a Lithium Concentrate

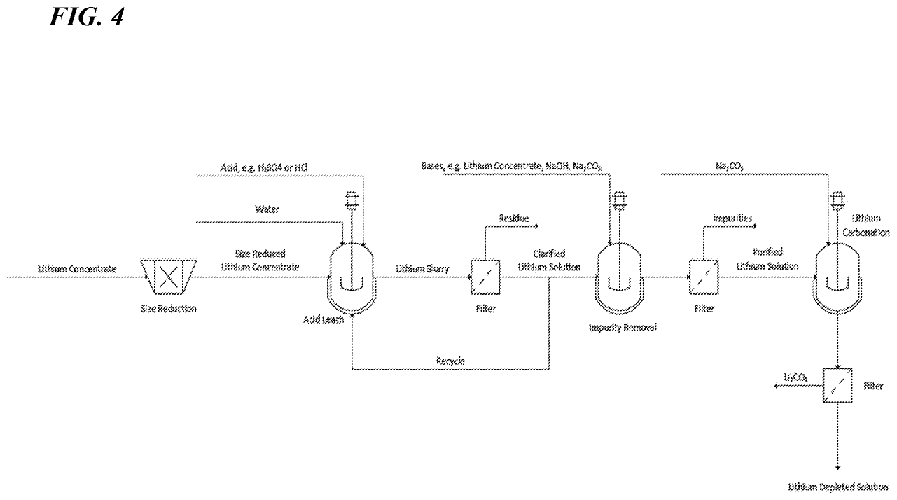

As discussed, the unique composition of the lithium concentrates, and the relatively high pH compared to known processes, described herein enable efficient extraction of lithium with minimal extraction of aluminum and other inseparable components. Overall, efficient lithium extraction of greater than 75% is possible with less than 5% Al leaching into the extract solution. FIG. 4 shows an example schematic of the extraction process described herein.

Disclosed herein is a process for extracting lithium from a lithium concentrate, comprising reducing the size of the lithium concentrate. The size may be reduced by any suitable mechanical means. The lithium concentrate may be reduced, for example, to between about 1 μm and about 1000 μm. In some embodiments, the lithium concentrate is reduced to between about 1 μm and about 100 μm; between about 50 μm and about 150 μm; between about 100 μm and about 200 μm; between about 200 μm and about 300 μm; between about 300 μm and about 400 μm; between about 400 μm and about 500 μm; between about 500 μm and about 600 μm; between about 600 μm and about 700 μm; between about 700 μm and about 800 μm; between about 800 μm and about 900 μm; or between about 900 μm and about 1000 μm.

The milled lithium concentrate is then exposed to acidic conditions. The processes described herein may comprise acidifying a slurry of the size-reduced lithium concentrate in water by addition of at least one acid. The slurry may be mixed or agitated to provide sufficient contact of the concentrate with the aqueous phase. In some embodiments, the slurry of the size-reduced lithium concentrate in water is acidified to a pH between about 2.5 and about 5. In certain embodiments, the slurry of the size-reduced lithium concentrate in water is acidified to a pH between about 2.5 and about 3; about 3 and about 3.5; about 3.5 and about 4; about 4 and about 4.5; or about 4.5 and about 5. In some embodiments, equilibration of the slurry to a pH of about 3.7, about 3.8, about 3.9, or about 4 indicates completion of lithium extraction. The relatively concentrated acid solutions of the extraction processes disclosed herein allow for high lithium extraction yield, but do not require uneconomical evaporation steps like known processes. Inorganic and organic acids may be used. In some embodiments, the acid is sulfuric acid or hydrochloric acid. Ideally, the ratio of the solid lithium concentrate to aqueous acid solution may be controlled prevent gelling of the solution. In some embodiments, the acidification process is exothermic. In some embodiments, additional heat is supplied to the acidic slurry. The reaction temperature may be maintained, for instance, between about 10° C. and about 100° C. In some embodiments, the temperature is maintained between about 40° C. and about 50° C.; about 50° C. and about 60° C.; about 60° C. and about 70° C. In some embodiments, the acidic slurry is filtered to remove solid residues.

The relatively high-pH extraction of this process, compared to known methods, produces extracts with high lithium yield and low aluminum extraction yield. In some embodiments, extraction yield of lithium from the lithium concentrate is about 75%, about 80%, about 85%, about 95%, or higher than about 95%. In some embodiments, the extraction yield of aluminum from the lithium concentrate is lower than about 5%, lower than about 4%, lower than about 3%, lower than about 2%, lower than about 1%, or lower than about 0.5%. Any amount of aluminum leaching is a significant disadvantage and complicates lithium recovery.

The lithium extraction processes may comprise neutralizing the acid slurry to a pH of about 7. This neutralization may be accomplished by addition of CaO or NaOH. In some embodiments, untreated lithium concentrate may be used as a neutralizer. This has the advantage that more lithium is leached and no new contaminants are introduced. The lithium extraction process may comprise filtering the solids from the neutralized slurry, thereby obtaining a clarified lithium-enriched solution of a lithium salt. After filtration, the residue can be recycled to the front end of the leaching process as described above. When recycling the solution, the neutralization step may be skipped until after the final leach. In some embodiments, calcium and magnesium impurities are removed from the clarified lithium-enriched solution. This can be accomplished, for instance, by standard industry methods, such as precipitation or ion exchange.

From the clarified lithium-enriched solution, lithium salts substantially free of impurities may be obtained. For instance, in some embodiments, a lithium salt is crystallized directly from the clarified lithium-enriched solution. In certain embodiments, the process comprises reacting the clarified lithium-enriched solution with sodium carbonate to produced solid lithium carbonate and isolating the solid lithium carbonate.

This leaching process proceeds with high efficiency, and with selectivity for lithium over aluminum and other impurities. In some embodiments, at least 75%, at least 80%, at least 85%, at least 90% or at least 95% of the lithium is extracted from the lithium concentrate. In certain embodiments, less than about 5%, less than about 4%, less than about 3%, less than about 2%, or less than about 1% of aluminum is extracted from the lithium concentrate. In some embodiments, aluminum is not present in the extracted lithium salt.

This process is useful for leaching lithium from lithium concentrates. In some embodiments, the process may extract lithium from a lithium concentrate comprising about 13% to about 30% Li₂O; about 25% to about 55% SiO₂; and about 25% to about 55% Al₂O₃. In some embodiments, the process may extract lithium from a lithium concentrate comprising about 13% to about 30% Li₂O; about 25% to about 55% SiO₂; about 25% to about 55% Al₂O₃; about 0.01% to about 5% CaO; and about 0% to about 5% MnO.

The foregoing description, for purposes of explanation, uses specific nomenclature to provide a thorough understanding of the invention. However, unless otherwise defined, all technical and scientific terms used herein have the same meaning as commonly understood by one of ordinary skill in the art to which this disclosure belongs. Thus, the following descriptions of specific embodiments of the invention are presented for purposes of illustration and description. They are not intended to be exhaustive or to limit the invention to the precise forms disclosed; obviously, many modifications and variations are possible in view of the teachings disclosed herein.

### Exemplary Embodiments

Some embodiments of this disclosure relate to Embodiment I, as follows:

Embodiment I-1. A lithium concentrate comprising:
about 13% to about 30% Li₂O;
about 25% to about 55% SiO₂; and
about 25% to about 55% Al₂O₃.

Embodiment I-2. The lithium concentrate of embodiment I-1, further comprising:
about 0.01% to about 5% CaO; and
about 0% to about 5% MnO.

Embodiment I-3. The lithium concentrate of embodiment I-1 or I-2, comprising about 20% to about 30% Li₂O.

Embodiment I-4. The lithium concentrate of any one of embodiments I-1 to I-3, comprising about 25% to about 30% Li₂O.

Embodiment I-5. The lithium concentrate of any one of embodiments I-1 to I-4, comprising less than about 1% CaO.

Embodiment I-6. The lithium concentrate of any one of embodiments I-1 to I-5, comprising less than about 1% MnO.

Embodiment I-7. A process comprising:
feeding lithium batteries, battery scrap, or battery components into a furnace;
blowing or injecting an oxygen-containing gas into the furnace to produce a metal phase and a lithium concentrate phase, wherein heating is autothermal; and
separating the metal phase from the lithium concentrate phase.

Embodiment I-8. The process according to embodiment I-7, wherein the flow of said oxygen-containing gas is controlled to selectively deport individual elements to the metal phase or to the lithium concentrate phase.

Embodiment I-9. The process according to embodiment I-8, wherein the flow of said oxygen-containing gas is controlled to maintain the temperature between about 1350° C. and about 1800° C.

Embodiment I-10. The process according to any one of embodiments I-7 to I-9, wherein lithium and aluminum present in the lithium batteries, battery scrap, or battery components are oxidized.

Embodiment I-11. The process according to embodiment I-10, wherein the oxidized lithium and aluminum deport to the lithium concentrate phase.

Embodiment I-12. The process according to any one of embodiments I-7 to I-11, wherein non-aluminum and non-lithium metals present in the lithium batteries, battery scrap, or battery components are reduced.

Embodiment I-13. The process according to embodiment I-12, wherein the non-aluminum and non-lithium metals deport to the metal phase.

Embodiment I-14. The process according to any one of embodiments I-7 to I-13, wherein SiO₂ is added.

Embodiment I-15. The process according to any one of embodiment I-14, wherein the SiO₂ is added to the lithium concentrate phase.

Embodiment I-16. The process according to any one of embodiments I-7 to I-15, wherein the metal phase is a liquid and is decanted from the solid lithium concentrate phase.

Embodiment I-17. The process according to any one of embodiments I-7 to I-16, wherein a fluidizer is not added.

Embodiment I-18. The process according to any one of embodiments I-7 to I-17, wherein no external heating is used.

Embodiment I-19. The process according to any one of embodiments I-7 to I-18, producing the lithium concentrate of any one of embodiments I-1 to I-6.

Embodiment I-20. A process for extracting lithium from a lithium concentrate, comprising:
reducing the size of the lithium concentrate;
acidifying a slurry of the size-reduced lithium concentrate in water by addition of at least one acid;
neutralizing the acidic slurry to a pH of about 7; and
filtering the solids from the neutralized slurry, thereby obtaining a clarified lithium-enriched solution of a lithium salt.

Embodiment I-21. The process according to embodiment I-20, wherein the lithium concentrate is reduced in size to between about 50 μm and about 150 μm.

Embodiment I-22. The process according to embodiment I-20 or I-21, wherein the acid is sulfuric acid or hydrochloric acid.

Embodiment I-23. The process according to any one of embodiments I-20 to I-22, wherein the slurry of the size-reduced lithium concentrate in water is acidified to a pH between about 2.5 and about 5.

Embodiment I-24. The process according to any one of embodiments I-18 to I-23, further comprising:

removing calcium and magnesium impurities from the clarified lithium-enriched solution.

Embodiment I-25. The process according to any one of embodiments I-18 to I-24, further comprising:
reacting the clarified lithium-enriched solution with sodium carbonate to produce solid lithium carbonate; and
isolating the solid lithium carbonate.

Embodiment I-26. The process according to any one of embodiments I-18 to I-25, wherein at least 80% of the lithium is extracted from the lithium concentrate.

Embodiment I-27. The process according to any one of embodiments I-18 to I-26, wherein aluminum is not present in the extracted lithium salt.

Embodiment I-28. The process according to any one of embodiments I-18 to I-27, wherein the lithium concentrate is a lithium concentrate of any one of embodiments I-1 to I-6.

### EXAMPLES

### Example 1: A High-Lithium-Content Lithium Concentrate May be Produced from LIBs

A lithium concentrate was produced from LIBs and their components in a rotary furnace equipped with a burner capable of blowing oxygen-containing gases into the furnace, or capable of combusting an oxygen-containing gas and natural gas.

Lithium containing batteries, their components, and scraps were fed into the furnace at 300 kg/hr. While batteries were fed, 90 Nm³/hr of oxygen was blown into the vessel and the furnace was rotated at 2 RPM. The oxygen flow was chosen to maintain the furnace temperature between 1400° C. and 1500° C. No external heat source was necessary. Additionally, the oxygen settings were chosen so that the majority of Ni, Co, and other non-lithium and non-aluminum metals were reduced and deported to the metal phase. Rotation settings were chosen to ensure adequate mixing of the feed and improved kinetics and heat transfer. Under these conditions, the metal phase was made molten, while the metal oxide phase remained a solid.

Once 2000 kg of batteries were fed in the furnace, the furnace was tilted to decant the molten metal from the metal oxide phase. After the metal was removed, 150 kg of SiO₂ were fed, while 30 Nm³/hr natural gas and 60 Nm³/hr oxygen were combusted, to flux, add heat, and fluidize the solid metal oxides forming a molten lithium concentrate. The furnace was once again tilted to remove the molten lithium concentrate.

The composition of the lithium concentrate is shown in Table 1.

TABLE 2
Composition of a lithium concentrate
produced from lithium batteries

| | Mass, | Ni, | Fe, | Cu, | Co, | Li₂O, | Al₂O₃, | SiO₂, |
|---|---|---|---|---|---|---|---|---|
| | kg | % | % | % | % | % | % | % |
| Input | | | | | | | | |
| Batteries | 2000 | 19 | 17 | 6 | 1 | 4 | 8 | — |
| Silica | 150 | — | — | — | — | — | — | 100 |
| Output | | | | | | | | |
| Alloy | 900 | 43 | 38 | 14 | 2 | — | — | — |
| Li | 340 | 0.02 | 0.2 | 0.02 | 0.03 | 22 | 43 | 44 |
| Concentrate | | | | | | | | |

Notably, the lithium concentrate contained 22% Li₂O, substantially higher than known processes for recycling LIBs. Similar conditions may be used to produce additional lithium concentrates with compositions shown in Table 2.

TABLE 3
Additional composition of lithium concentrates produced from lithium batteries

| | Li₂O | Al₂O₃ | SiO₂ | CaO | Mn | Fe | Ni | Co |
|---|---|---|---|---|---|---|---|---|
| Composition 1 | 23 | 42 | 34 | 0.1 | 0.02 | 0.17 | 0.17 | 0.01 |
| Composition 2 | 22 | 40 | 37 | 0.3 | 0.1 | 0.44 | 0.12 | 0.02 |
| Composition 3 | 22 | 43 | 35 | 0.02 | 0.02 | 0.38 | 0.1 | 0.02 |
| Composition 4 | 20 | 38 | 38 | 3.6 | 0.2 | 0.62 | 0.07 | 0.05 |
| Composition 5 | 21 | 37 | 40 | | | | | |
| Composition 6 | 19 | 38 | 42 | | | | | |
| Composition 7 | 20 | 43 | 36 | | | | | |
| Composition 8 | 24 | 45 | 30 | | | | | |
| Composition 9 | 18 | 30 | 51 | | | | | |
| Composition 10 | 17 | 30 | 51 | | | | | |
| Composition 11 | 23 | 45 | 29 | | | | | |
| Composition 12 | 14 | 30 | 53 | | | | | |

### Example 2: Lithium May be Selectively Leached from a Lithium Concentrate Containing Other Metals to Produce a Pure, Economically Useful Lithium Compound

Lithium was extracted from a lithium concentrate with a composition shown in Table 3.

TABLE 3
Lithium concentrate composition used in a lithium leaching process

| | Li₂O % | Al₂O₃ % | SiO₂ % | CaO % |
|---|---|---|---|---|
| Li Concentrate | 21 | 40 | 36 | 3 |

The lithium concentrate was sized-reduced using a crusher and mill to about 150 μm. Size reduction in this case is optional, but improves leaching kinetics, thereby reducing processing time. The milled lithium concentrate was then contacted with water in an agitated tank. A solid to liquid ratio of 1 to 10 was maintained throughout the process. Sulfuric acid was dosed such that pH did not go lower than about 3 and above about 4. 20% excess sulfuric acid was used relative to the lithium. Once addition of the sulfuric acid was complete, the solution was left to stir. The reaction temperature was maintained at about 60° C. throughout the process. Heat was supplied from the reaction itself, e.g. addition of acid, and by an external heat source. The endpoint of the reaction was determined by monitoring the pH. When the pH stopped increasing, the reaction was deemed complete. This occurred after 1.5 to 2.0 hours as the pH leveled out around 3.8. The solution was then filtered, producing a residue and relatively pure lithium solution. The residue was washed to recover the remaining lithium as well.

Lithium silicates are selectively leached relative to lithium aluminates at higher pHs (i.e., at about pH 4). When lithium aluminates are leached, aluminum enters the solution along with lithium. Aluminum is a contaminant and complicates recovery of lithium. However, when aluminum is precipitated, lithium co-precipitates as an aluminate or adsorbs to aluminum hydroxide, resulting in significant loss of lithium. Table 4 shows the composition of the lithium filtrate after acid leaching. Notably, the filtrate contained only 0.5% of the aluminum present in the initial lithium concentrate.

TABLE 4
Composition of filtrate with % recovery from lithium concentrate

| Element | Filtrate, g/L | Yield, % |
|---|---|---|
| Li | 7.91 | 86% |
| Al | 0.09 | 0.5% |
| Ca | 0.5 | 76% |
| Mg | 0.2 | 98% |
| Ni | 0.03 | 19% |
| Co | 0.02 | 47% |
| Fe | 0.4 | 68% |
| Cu | 0.0 | 0% |

The lithium filtrate was then neutralized to a pH of about 7 to remove impurities. Fresh lithium concentrate was used as a neutralizer. The use of fresh lithium concentrate is advantageous, as more lithium is leached and no new contaminants are introduced. After further filtration, the residue can be recycled to the front-end of the leach process. Furthermore, the lithium solution can be recycled multiple times through the leach step to further increase the amount of Li solution. This avoids a costly evaporation step.

Lithium products can be created from the solution via variety of pathways. For instance, lithium sulfate can then be crystallized from solution. Alternatively, the solution can be used to produce lithium carbonate or lithium hydroxide using standard industry methods. For example, the pH of the Li solution was increased to 12 using NaOH to precipitate Mg. Mg precipitate was then filtered from the solution and washed. Then Na₂CO₃ was added to precipitate calcium. The calcium precipitate was then filtered and washed. Finally, the temperature was increased to about 90° C. and Na₂CO₃ was added to precipitate Li₂CO₃. The Li₂CO₃ was then washed and dried.

1. A lithium concentrate comprising:
about 13% to about 30% Li₂O;
about 25% to about 55% SiO₂; and
about 25% to about 55% Al₂O₃.

2. The lithium concentrate of claim 1, further comprising:
about 0.01% to about 5% CaO; and
about 0% to about 5% MnO.

3. The lithium concentrate of claim 1, comprising about 20% to about 30% Li₂O.

4. The lithium concentrate of claim 1, comprising about 25% to about 30% Li₂O.

5. The lithium concentrate of claim 1, further comprising less than about 1% CaO.

6. The lithium concentrate of claim 1, further comprising less than about 1% MnO.

7. A process comprising:
feeding lithium batteries, battery scrap, or battery components into a furnace;
blowing or injecting an oxygen-containing gas into the furnace to produce a metal phase and a lithium concentrate phase, wherein heating is autothermal; and
separating the metal phase from the lithium concentrate phase.

8. The process according to claim 7, wherein the flow of said oxygen-containing gas is controlled to selectively deport individual elements to the metal phase or to the lithium concentrate phase.

9. The process according to claim 8, wherein the flow of said oxygen-containing gas is controlled to maintain the temperature between about 1350° C. and about 1800° C.

10. The process according to claim 7, wherein lithium and aluminum present in the lithium batteries, battery scrap, or battery components are oxidized.

11. The process according to claim 10, wherein the oxidized lithium and aluminum deport to the lithium concentrate phase.

12. The process according to claim 7, wherein non-aluminum and non-lithium metals present in the lithium batteries, battery scrap, or battery components are reduced.

13. The process according to claim 12, wherein the non-aluminum and non-lithium metals deport to the metal phase.

14. The process according to claim 7, wherein SiO₂ is added.

15. The process according to claim 14, wherein the SiO₂ is added to the lithium concentrate phase.

16. The process according to claim 7, wherein the metal phase is a liquid and is decanted from the solid lithium concentrate phase.

17. The process according to claim 7, wherein a fluidizer is not added.

18. The process according to claim 7, wherein no external heating is used.

19. The process according to claim 7, producing the lithium concentrate of a lithium concentrate comprising:
about 13% to about 30% Li₂O;
about 25% to about 55% SiO₂; and
about 25% to about 55% Al₂O₃.

20. A process for extracting lithium from a lithium concentrate, comprising:
reducing the size of the lithium concentrate;
acidifying a slurry of the size-reduced lithium concentrate in water by addition of at least one acid;
neutralizing the acidic slurry to a pH of about 7; and
filtering the solids from the neutralized slurry, thereby obtaining a clarified lithium-enriched solution of a lithium salt.

21. The process according to claim 20, wherein the lithium concentrate is reduced in size to between about 50 μm and about 150 μm.

22. The process according to claim 20, wherein the acid is sulfuric acid or hydrochloric acid.

23. The process according to claim 20, wherein the slurry of the size-reduced lithium concentrate in water is acidified to a pH between about 2.5 and about 5.

24. The process according to claim 20, further comprising:
removing calcium and magnesium impurities from the clarified lithium-enriched solution.

25. The process according to claim 20, further comprising:
reacting the clarified lithium-enriched solution with sodium carbonate to produce solid lithium carbonate; and
isolating the solid lithium carbonate.

26. The process according to claim 20, wherein at least 80% of the lithium is extracted from the lithium concentrate.

27. The process according to claim 20, wherein aluminum is not present in the extracted lithium salt.

28. The process according to claim 20, wherein the lithium concentrate is a lithium concentrate of comprising:
about 13% to about 30% Li₂O;
about 25% to about 55% SiO₂, and
about 25% to about 55% Al₂O₃.
